(19) United States
(12) Patent Application Publication
(10) Pub. No.: US 2019/0208605 A1
(43) Pub. Date: Jul. 4, 2019

(54) AUTOMATIC CONFIGURATION OF MULTIPLE BUS POWER SUPPLIES

(71) Applicant: OSRAM SYLVANIA Inc., Wilmington, MA (US)

(72) Inventors: Michael Ardai, Malden, MA (US); Masatoshi Honji, Westborough, MA (US); Ranjit Jayabalan, Boxborough, MA (US); Sivakumar Thangavelu, Westford, MA (US)

(73) Assignee: OSRAM SYLVANIA Inc., Wilmington, MA (US)

(21) Appl. No.: 16/331,785

(22) PCT Filed: Sep. 15, 2017
(86) PCT No.: PCT/US17/51929

§ 371 Date: Mar. 8, 2019

Related U.S. Application Data
(60) Provisional application No. 62/395,328, filed on Sep. 15, 2016.

(51) Int. Cl. H05B 37/02; H05B 37/03

(52) U.S. Cl. CPC H05B 37/0254; H05B 37/034

(57) ABSTRACT

A network power distribution system includes a plurality of networked digitally controlled lighting devices and a network powered network controller. Each of the digitally controlled lighting devices includes a device driver that coupled to the network. The device driver is selectively transitionable between a first operating mode in which the device driver provides a first voltage and a first current to the network and a second operating mode where the driver does not provide a voltage or current to the network. The network controller autonomously determines a number of device drivers that, in the first operating mode, at least meet the current draw of the network controller. The network controller then transitions the determined number of device drivers to the first operating mode. The network controller monitors the device drivers for faults and autonomously swaps device drivers to maintain network power.

### CROSS-REFERENCE TO RELATED APPLICATION

The present application is an international application and claims the benefit of, and priority of, U.S. Provisional Patent Application No. 62/395,328, filed Sep. 15, 2016, the entire contents of which are hereby incorporated by reference.

### TECHNICAL FIELD

The present invention relates to network power distribution, and more specifically, to the control of power supplies in a digitally controlled lighting device network.

### BACKGROUND

In a rapidly changing society, technology and personalization bring new opportunities and challenges to building design and management; to the impact building and utility management have on occupant lifestyles, work habits, health and wellbeing, to personal control of living and work environments in a shared or communal residential, educational, and/or work spaces. Building management systems assist in providing an environment appropriate for the activities taking place within interior and exterior spaces about the building. For example, a building management system in a college lecture hall may include an interior lighting system that provides bright lighting while classes are not in session to enable safe ingress to and egress from the lecture hall. When classes are in session, the lighting system may dim a portion of the lighting in the lecture hall while maintaining bright illumination in other portions of the lecture hall. During times when the lecture hall is unoccupied, motion sensors or timers may be used to place illumination in a low energy mode where lighting is severely dimmed or even turned off.

### SUMMARY

The systems, methods, and apparatuses described herein beneficially and advantageously use the signaling voltage generated by device drivers a first portion of a plurality of networked digitally controlled lighting devices to power one or more network devices, such as one or more network controllers. Such an arrangement surprisingly stands in contradiction to the usual arrangement where one or more dedicated network power supplies, usually disposed in or forming a portion of the network controller, provide network power. The systems, methods, and apparatuses described herein take advantage of the voltage output (i.e., the power) generated by the device drivers in network connected digitally controlled lighting devices to provide network power, thereby eliminating the use of a network controller or similar independent power supply to power the network.

Although described in detail with regard to the Digitally Addressable Lighting Interface (“DALI”) protocol, one of ordinary skill in the relevant arts will readily appreciate the systems, methods, and apparatuses described herein may be readily adapted to other network protocols such as 1-wire bus protocols, such as Maxim Integrated's 1-wire bus (Maxim Integrated, Inc., San Jose, Calif.), and 2-wire bus protocols, such as Ockam's marine bus (Ockam Instruments, Inc., Milford, Conn.).

A DALI network consists of a network controller and a plurality of digitally controlled lighting devices (electrical ballasts, LED drivers, dimmers, and similar equipment), each equipped with a DALI device driver. The DALI network controller monitors and controls the operation of each digitally controlled lighting device by means of a bi-directional data exchange via a 2-wire network. The DALI communication protocol permits individual addressing of digitally controlled lighting devices and supports multicast and broadcast messages that permit simultaneous addressing of multiple digitally controlled lighting devices. Under the DALI protocol, the network controller assigns a unique static address in a numeric range 0 to 63 to each digitally controlled lighting device, making possible up to 64 devices in a DALI network. Under the DALI protocol, data is transferred between the network controller and each of the digitally controlled lighting devices over a two-wire bus by means of an asynchronous, half-duplex, serial protocol, with a fixed data transfer rate of 1200 bit/s. The DALI 2-wire network may have a serial topography, a star topography or a combination of serial and star topography. Data is transmitted across the 2-wire network using Manchester encoding (rising voltage=logical 1; falling voltage=logical 0). Signal levels are defined as 0±4.5 V to represent a logical “0” and 16±6.5 V to represent a logical “1”. Although varying by manufacturer, generally the DALI network controller may handle a maximum network current of 250 mA.

Each digitally controlled lighting device in a DALI network includes a device driver that includes a power supply, power converter, and device control circuitry. The device driver receives messages from the network controller, responds to messages received from the network controller, and controls one or more operational parameters of the respective digitally controlled lighting device to which the device driver is operably and conductively coupled. To respond to a network controller message, the device control circuitry selectively, reversibly, transitions the device driver network output (at 1200 baud) between a high potential (+16 VDC+/−6.5 VDC− a “first operating mode”) and a lower potential (0 VDC+/−4.5 VDC− a “second operating mode”) by shorting the network output using switching element, such as a field effect transistor (“FET”).

The systems, methods, and apparatuses disclosed herein beneficially maintain the device drivers in a first portion of a plurality of digitally controlled lighting devices in the first operating mode to provide 16 VDC power to the 2-wire network. The network controller determines the number of digitally controlled lighting device drivers to include in the first portion of the plurality of digitally controlled lighting devices based on the current draw of the network controller, the maximum allowable network current (e.g., 250 mA), and the current output of each of the device drivers when placed in the first operating mode.

For example, in a DALI compliant network may have a maximum current of 250 mA, a network controller with a 100 mA current draw, and ten (10) DALI digitally controlled lighting devices, each having a device driver capable of providing 75 mA at 16 VDC in the first operating mode. In such a scenario, the network controller may select three (3) digitally controlled lighting device drivers to include in the first portion of the plurality of digitally controlled lighting devices and may cause each of the three device drivers to enter the first operating mode (+16 VDC, 75 mA output to the network). The combined current from the three digitally controlled lighting device drivers included in the first portion totals 225 mA-less than the network maximum of 250 mA. The network controller power requirement (100 mA) is fulfilled by the power output of two digitally controlled lighting device drivers (150 mA) while the third digitally controlled lighting device driver provides spare power output capacity should one of the digitally controlled lighting device drivers included in the first portion unexpectedly fail. The network controller may the remaining seven (7) digitally controlled lighting device drivers connected to the network to remain in the second operating mode (0 VDC, 0 mA output to network).

The network controller may monitor the performance of each of the device drivers included in the first portion of the digitally controlled lighting devices to detect one or more fault conditions, such as an over-voltage or under-current condition. Upon detecting a fault condition, the network controller may cause the faulty device driver to transition from the first operating mode to the second operating mode wherein the device driver ceases to provide a network power output. The network controller may further cause one of the digitally controlled lighting devices included in the remaining portion of the plurality of digitally controlled lighting devices to transition the device driver from the second operating mode to the first operating mode where the device driver begins supplying a network power output. The ability to detect potential network power supply issues and proactively autonomously swap power supplies offers significant advantages over competitive systems which use a manual swap operation. In addition, network reliability is significantly enhanced and a formed single point of failure (e.g., a single network power supply in the network controller) is replaced with a more robust distributed power supply network.

Upon initial power up of a DALI network, the network controller autonomously polls the connected digitally controlled lighting devices to identify which includes a device driver suitable for and/or capable of providing power to other network connected devices. The network controller may also autonomously poll each of the identified device drivers to determine one or more power output parameters (output voltage, output current, etc.). With device driver power output information received from each of the network connected digitally controlled lighting devices, a fixed network maximum current, and a known network controller current draw, the network controller determines a number “N” of device drivers (i.e., the first portion of the plurality of digitally controlled lighting devices) to meet the current draw of the network controller. The network controller then autonomously transitions the device drivers in each of the first portion of the digitally controlled lighting devices to the first operating mode in which the device drivers provide a power output sufficient to power the network controller to the DALI network.

Thus, the systems, methods, and apparatuses disclosed herein beneficially permit the network controller to autonomously: (1) determine which digitally controlled lighting devices include a device driver capable of providing network power; (2) determine one or more device driver power output parameters; (3) determine one or more network operating parameters; (4) determine a number “N” of device drivers to at least meet the one or more network operating parameters; (5) transition N+1 device drivers to a first operating mode to provide network power; (6) monitor device driver performance to detect a fault condition; (7) transition faulty device drivers from the first operating mode (power supplied to DALI network) to a second operating mode (power not supplied to DALI network); and (8) transition additional device drivers in the remaining portion of the plurality of digitally controlled lighting devices from the second operating mode to the first operating mode.

In some embodiments, a network power distribution system is provided. The network power distribution system may include: a plurality of digitally controlled lighting devices, each of the plurality of digitally controlled lighting devices communicably coupled to a 2-wire network and including: a device driver to: provide a signal to the 2-wire network, the signal selectively, reversibly, transitionable between a first voltage and a second voltage; a network controller that includes: a network control circuit communicably couplable to each of the device drivers via the 2-wire network, the network controller to receive power at the first voltage, via the 2-wire network, from a first portion of the plurality of device drivers; and a non-transitory storage medium containing machine-readable instructions that, when executed by the network controller cause the network control circuit to: scan each device driver to determine at least one device power supply parameter associated with a power output to the 2-wire network by the respective device driver, the power output provided at the first voltage and a first current; determine at least one network power parameter; and select a first portion of the digitally controlled lighting devices from the plurality of digitally controlled devices, the first portion of digitally controlled lighting devices selected based on the power supply parameter of the device driver included in each of the first portion of digitally controlled lighting devices and the at least one network power parameter; and cause the device drivers included in the first portion of the digitally controlled lighting devices to operate in a first operating mode where the respective device driver provides a power output to the 2-wire network at the first voltage and the first current.

In some embodiments, a network power distribution method is provided. The method may include: scanning, by a network control circuit, each of a plurality of networked digitally controlled lighting devices to determine at least one device power supply parameter associated with a device driver included in each at least some of the plurality of digitally controlled lighting devices; determining at least one network power parameter; selecting a first portion of the digitally controlled lighting devices from the plurality of digitally controlled devices, the first portion of digitally controlled lighting devices selected, by the network control circuit, based on the power supply parameter of the device driver included in each of the first portion of digitally controlled lighting devices and the at least one network power parameter; and autonomously causing, by the network control circuit, the device drivers included in the first portion of the digitally controlled lighting devices to operate in a first operating mode where the respective device driver provides power output to the 2-wire network at the first voltage and a first current.

In some embodiments, a non-transitory, machine-readable, storage medium is provided. The non-transitory storage medium includes instructions that, when executed by a network control circuit, cause the network control circuit to: scan each of a plurality of networked digitally controlled lighting devices to determine at least one device power supply parameter associated with a device driver included in each respective one of the plurality of digitally controlled lighting devices; determine at least one network power parameter; select a first portion of the digitally controlled lighting devices from the plurality of digitally controlled devices, the first portion of digitally controlled lighting devices selected, by the network control circuit, based on the power supply parameter of the device driver included in each of the first portion of digitally controlled lighting devices and the at least one network power parameter; and autonomously cause, by the network control circuit, the device drivers included in the first portion of the digitally controlled lighting devices to transition to a first operating mode in which the respective device driver provides a power output to the 2-wire network, the power output at the first voltage and a first current.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a schematic of an illustrative digitally controlled lighting system that includes a network controller communicably coupled, via a network, to a plurality of digitally controlled lighting devices, each having a respective, operably coupled, device driver, in accordance with at least one embodiment described herein.

FIG. 2 is an input/output diagram of a system that includes a network control circuit coupled to a two-wire network, in accordance with at least one embodiment described herein.

FIG. 3 is a block diagram of an illustrative system that includes a network controller communicably coupled to a plurality of digitally controlled lighting devices via a network, in accordance with at least one embodiment described herein.

FIG. 4 is an illustrative message generated using a DALI compliant messaging protocol, in accordance with at least one embodiment described herein.

FIG. 5 is a high-level flow diagram of an illustrative method of autonomously powering a network controller using power provided to the network by a device drivers included in a first portion of a plurality of digitally controlled lighting devices, in accordance with at least one embodiment described herein.

FIG. 6 is a high-level flow diagram of an illustrative method of autonomously detecting by the network control circuit a faulty device driver included in the first portion of digitally controlled lighting devices and autonomously causing the faulty device driver to transition from the first operating mode to the second operating mode, in accordance with at least one embodiment described herein.

FIG. 7 is a high-level flow diagram of an illustrative method of autonomously transitioning a device driver included in the remaining portion of digitally controlled lighting devices to the first operating mode in response to detecting a faulty device driver included in the first portion of digitally controlled lighting devices, in accordance with at least one embodiment described herein.

FIG. 8 is a high-level flow diagram of an illustrative method of autonomously generating a human perceptible output responsive to detecting a faulty device driver included in the first portion of digitally controlled lighting devices, in accordance with at least one embodiment described herein.

### DETAILED DESCRIPTION

As used herein, the term “digitally controlled lighting device” should be understood to refer to any number, combination, and/or form of light producing elements. Such light producing elements may be disposed or otherwise coupled to a luminaire or similar fixture. Example light producing elements include, but are not limited to, LEDs, fluorescent tubes, incandescent lamps, halogen lamps, and similar. Further, the term “digitally controlled lighting device” should also be understood to refer to any number and/or combination of devices used to control the luminous output, color, temperature, and similar of such light producing elements. Such control devices may be incorporated into a luminaire or light fixture or may be stand-alone (i.e., remotely mounted) devices. Example control devices include, but are not limited to, motion sensors, proximity sensors, switches, dimmers, keypads, photoelectric cells, piezoelectric devices, and similar systems, components, and/or devices capable of controlling, altering or adjusting one or more operating or output parameters of a light producing element (intensity, luminous output, color, warmth, etc.).

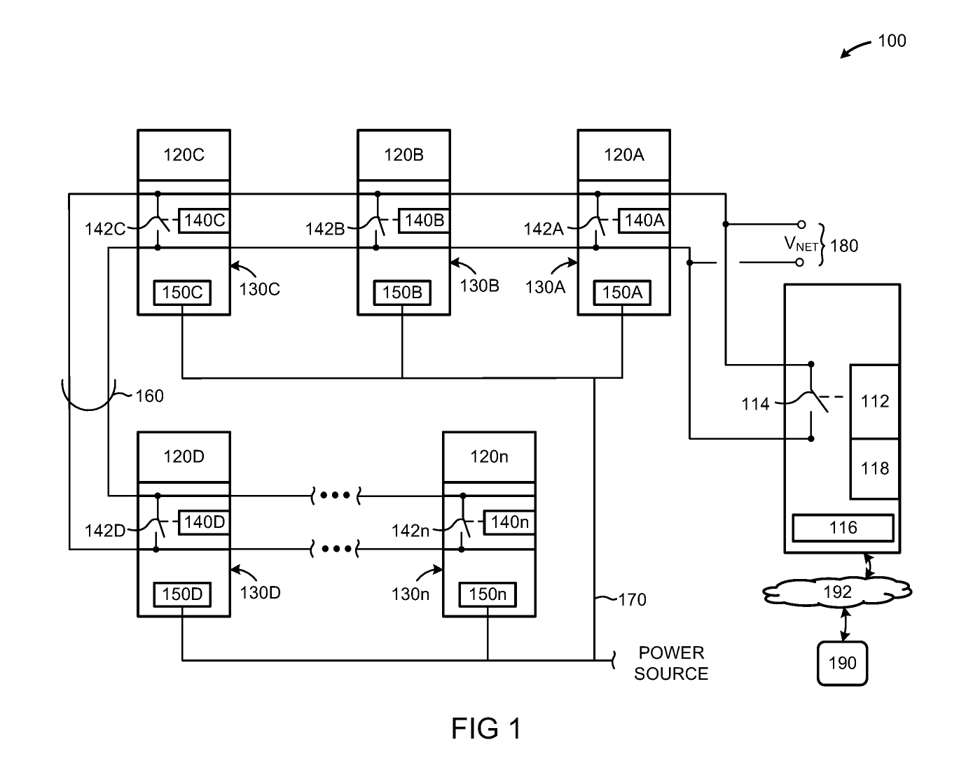

FIG. 1 is a schematic of an illustrative digitally controlled lighting system 100 that includes a network controller 110 communicably coupled, via a network 160, to a plurality of digitally controlled lighting devices 120A-120n (collectively, “digitally controlled lighting devices 120”), each having a respective, operably coupled, device driver 130A-130n (collectively, “device drivers 130”), in accordance with at least one embodiment described herein. Each device driver 130A-130n includes respective device control circuitry 140A-140n (collectively, “device control circuitry 140”) operably and/or conductively coupled to a switching element 142A-142n (collectively, “switching elements 142”). Each device driver 130A-130n also includes a respective power supply 150A-150n (collectively, “power supplies 150”) that provides power to the respective digitally controlled lighting device 120A-120n, the device control circuitry 140A-140n and, when the device controller is placed in a first operating mode, to the network 160. At least one external power source 170, such as a commercial, industrial, or residential electrical grid, supplies power to each of the power supplies 150.

The network 160 may include any single or two-wire network capable of supporting digital communication between the digitally controlled lighting devices 120 and the network controller 110. In some embodiments, the network 160 may include a two-wire network in which a potential difference is maintained between the conductors at a first network voltage. In some embodiments, the first network voltage (i.e., the potential difference between a 1-wire network and ground or between two conductors in a two-wire network) may be greater than 5 VDC, greater than 10 VDC, greater than 15 VDC, greater than 20 VDC, or greater than 25 VDC. In some embodiments, the potential difference between conductors in a 2-wire network may be approximately 16 VDC.

Data may be bidirectionally communicated across the network 160 by altering the potential difference between a wire conductor and ground in 1-wire networks or between conductors in a 2-wire networks. In some embodiments, the potential difference is reduced to a second voltage by selectively shorting the conductor to ground in 1-wire networks or by selectively shorting the conductors together in 2-wire networks. In some embodiments, the second network voltage may include a potential difference of approximately 0 VDC, obtained by selectively shorting the conductor to ground in 1-wire networks or by selectively shorting across the network conductors in 2-wire networks.

For example, to communicate a message to a digitally controlled lighting device 120, the network controller 110 may selectively, reversibly, short across the conductors forming the two-wire network 160 using one or more switching elements 114 to form a binary message having a defined format. To respond to a message received from the network controller 110, a device driver 130A-130n may similarly, selectively, reversibly short the conductors forming the two-wire network 160 using one or more switching elements 142A-142n to form a binary message having the defined format. When the switching elements 142A-142n remain open, the device driver 130 has the capability to enter a first operating mode in which the respective device driver supplies+16 VDC power to the network 160. Thus, it is possible to power the network 160 and the network controller 110 using a first portion of the device drivers 130 placed in the first operating mode, where the device driver 130 supplies+16 VDC power to the network 160.

The network controller 110 may communicate with each of the device drivers 130 to determine one or more operating parameters associated with the device driver 130. For example, the network controller 110 may communicate with the device driver 130 to determine a first voltage output and/or a first current output when the device driver 130 is placed in the first operating mode. In some embodiments, each of the device drivers 130 may have the same nominal operating parameters when in the first operating mode (e.g., each of the device drivers 130 may have a first voltage output of about +16 VDC and a first current output of about 75 mA when in the first operating mode). In some embodiments, some of the device drivers 130 may have the same first voltage output, but a different first current output when placed in the first operating mode.

The network controller 110 may store otherwise retain information and/or data representative of one or more network operating parameters, such as information and/or data representative of a maximum allowable network current. The network controller 110 may store or otherwise retain information and/or data representative of one or more network controller operating parameters, such as information and/or data representative of an operating current draw or demand of the network controller 110. Such information and/or data may be stored in one or more non-transitory memories or storage devices 116 communicably coupled to the network controller 110. Using the device driver output parameter information received from each of the device drivers 130, the network operating parameters, and the network controller operating parameters, the network controller 110 determines a first portion of device drivers 130 needed to power the network 160 to a level sufficient for powering the network controller 110 while remaining within allowable network operating parameters. The network controller 110 then places the first portion of device drivers 130 in the first operating mode in which the device drivers 130 provide power to the network 160. The network controller 110 places the remaining portion of device drivers 130 in a second operating mode in which the device drivers 130 do not provide power to the network 160.

For example, a DALI protocol lighting network with a maximum current limit of 250 mA may include 20 digitally controlled lighting devices (addresses 00 to 19), each equipped with a respective device driver capable of outputting 25 mA at 16 VDC. The network controller 110 may have a current draw, in operation, of 130 mA. Upon initial system power-up, the network controller 110 determines the first portion of the digitally controlled lighting devices 120 will include at least seven (7) device drivers: six (6) device drivers 130 to provide the 150 mA current to meet the 130 mA current draw of the network controller 110 and one (1) device driver to provide 25 mA of additional current such that a failure of any one of device driver included in the first portion of digitally controlled lighting devices 120 does not compromise network controller operation. With substantially equal device driver power output parameters, the network controller 110 groups device driver addresses 00 through 06 in the first portion of digitally controlled lighting devices 120, and places the device driver 130 in each of the digitally controlled lighting devices 120 included in the first portion in the first operating mode, providing power to the network 160. The network controller places all remaining device drivers 130 in the second operating mode in which the device drivers do not provide power to the network 160.

Continuing with the above example, if in operation the network controller 110 detects a fault condition in device driver 04, the network controller 110 autonomously transitions device driver 04 from the first operating mode to the second operating mode in which device driver 04 is no longer providing power to network 160. The network controller 110 autonomously selects the next available device driver (address 07) and causes the device driver 130 to transition from the second operating mode to the first operating mode where device driver 07 supplies power to the network 160. Thus, at the conclusion of the transition, the first portion of digitally controlled lighting devices includes device drivers 00-03, and 05-07; the remaining portion of digitally controlled lighting devices includes device drivers 04 and 08-19).

As depicted in FIG. 1, the network controller 110 includes a network control circuit 112 that controls the operation of a switching element 114 to generate messages on the network 160. In operation, the network controller 110 sequentially, reversibly alters the network voltage 180 by opening switching element 114 (network potential=16 VDC) and closing switching element 114 (network potential=0 VDC) at a defined baud or bit rate, such as 1200 baud. The network controller 110 may also include a non-transitory memory or storage device 116 and a back-up power source 118.

The network control circuit 112 may include any number and/or combination of systems and/or devices capable of executing machine-readable instructions and providing the functions described in detail herein. The machine-readable instructions executed by the network control circuit 112 may be stored in whole or in part locally within the network control circuit 112 and/or stored remotely in whole or in part within the non-transitory memory or storage device 116 or in a communicably coupled remote device 190, such as a cloud based server, communicably coupled via one or more wired or wireless networks 192, such as the Internet, to the network controller 110.

The switching element 114 may include any number and/or combination of switching elements controlled by the network control circuit 112 and capable of operating at speeds of up to 500 baud; 1000 baud; 1200 baud; 2600 baud; 5000 baud; or 9600 baud. In some embodiments, the switching element 114 may include a plurality of switching elements 114A-114n disposed in parallel. In some embodiments, the switching element 114 may include a semiconductor switching element, such as a field-effect transistor (FET).

The non-transitory memory or storage device 116 may include any number and/or combination of storage media, systems, and/or devices capable of storing or otherwise retaining digital information and/or data. In some embodiments, the non-transitory memory or storage device 116 may include any combination of electromagnetic, electroresistive, optical, quantum, molecular, or similar storage systems and/or devices. In some embodiments, the non-transitory memory or storage device 116 may store or otherwise retain at least some of the machine-readable instruction sets executed by the network control circuit 112. In some embodiments, the non-transitory memory or storage device 116 may store or otherwise retain information and/or data representative of a maximum allowable network current or similar other network operating limitations and/or parameters. In some embodiments, the non-transitory memory or storage device 116 may store or otherwise retain information and/or data representative of an operating current draw associated with the network controller 110. In some embodiments, the non-transitory memory or storage device 116 may include an electrically erasable programmable read-only memory (EEPROM) or similar device to store or otherwise retain information and/or data.

The back-up power source 118 may include any number and/or combination of systems and/or devices suitable for providing power to the network controller 110 when either the network control circuit 112 or one of the device drivers 130 is communicating via the network 160. In the absence of messages on the network 160, the network controller 110 receives power from the device drivers 130 in the first portion of the plurality of digitally controlled lighting devices 120. However, when a message is communicated either from the network control circuit 112 to one or more device drivers 130 or from one or more device drivers 130 to the network control circuit 112, the flow of power to the network controller may be interrupted. In such instances, the back-up power source 118 continues to power the network controller 110 until the flow of power from the device drivers 130 in the first portion of the plurality of digitally controlled lighting devices 120 is restored. The back-up power source 118 may include a uninterruptible power supply or similar energy storage device that is charged using either or both, the power received via the network 160 and/or an external power supply such as a commercial or industrial power grid. In some embodiments, the back-up power source 118 may include one or more capacitors, supercapacitors, ultracapacitors, or similar charge storage devices or systems.

The digitally controlled lighting devices 120 may include any number or combination of devices capable of receiving messages, including commands, from the network control circuit 112 and responsive to receipt of the message from the network control circuit 112, communicating information back to the network control circuit 112. Some or all of the digitally controlled lighting devices 120 may include, but are not limited to, light producing elements (LEDs, fluorescent tubes, incandescent lamps, halogen lamps, LED drivers, fluorescent ballasts, phase-cut dimmers, etc.), lighting controls (photosensors, motion sensors, switches, dimmers, etc.) or combinations thereof.

Each of the device drivers 130 includes at least device control circuitry 140, a switching element 142 that is controlled by the device control circuitry 140 and a power supply 150 that powers the device driver 130. The device driver 130 may communicate with the network controller 110 using any industry standard or proprietary communications protocol. For example, the device driver 130 may communicate with the network controller 110 using a DALI network communication protocol (IEC Standard 62386, latest version).

The device control circuitry 140 may include any number and/or combination of electronic components, semiconductor devices, and/or logic elements. In embodiments, the device control circuitry 140 may control one or more operational aspects of the fixture or luminaire to which the digitally controlled lighting device 120 is operably coupled. In embodiments, the device control circuitry 140 unidirectionally or bidirectionally communicates with the network control circuit 112 via the network 160. In embodiments, the device control circuitry 140 may receive messages from the network control circuit 112 and may adjust one or more operating parameters of the fixture or luminaire responsive to the messages received from the network control circuit 112. Such operating parameters may include, but are not limited to: illumination output color, illumination output intensity, or combinations thereof.

The device control circuitry 140 may include, but is not limited to: an application specific integrated circuit (ASIC); a reduced instruction set computer (RISC); a programmable gate array (PGA); a field programmable gate array (FPGA); a system-on-a-chip (SoC); a controller; a microcontroller; a processor; or a single- or multi-core microprocessor. In some embodiments, the device control circuitry 140 may include an 8-bit microcontroller unit (MCU).

The switching element 142 may include any number and/or combination of switching elements controlled by the network control circuit 112 and capable of operating at speeds of up to 500 baud; 1000 baud; 1200 baud; 2600 baud; 5000 baud; or 9600 baud. In some embodiments, the switching element 114 may include a plurality of switching elements 114A-114n disposed in parallel. In some embodiments, the switching element 114 may include a semiconductor switching element, such as a field-effect transistor (FET).

The device control circuitry 140 selectively and reversibly places the switching element 142 in one of at least two operating modes. When placed in a first operating mode, the switching element 142 is disposed in an electrically non-conductive state such that the potential difference between the conductors forming the two-wire network 160 is maintained at the first voltage. For example, the conductors may be maintained at a minimum potential difference of: greater than 9 VDC; greater than 10 VDC; greater than 15 VDC; greater than 20 VDC; or greater than 25 VDC. When placed in a second operating mode, the switching element 142 is in an electrically conductive state such that the two conductors forming the two-wire network are at the same potential, having a minimum potential difference of: less than 5 VDC; less than 3 VDC; less than 1 VDC; less than 0.50 VDC; less than 0.25 VDC or less than 0.10 VDC.

Although the switching element 142 is depicted in FIG. 1 as conductively coupled across or between the two conductors forming the two-wire network 160, other switching element and network configurations are possible and should be considered within the scope of this disclosure. For example, the switching elements in a single wire network may be disposed between the single conductor and ground such that when open, the single wire network operates at a first (i.e., higher) voltage and when closed, the single wire network is at ground potential.

The power supply 150 receives power from at least one external source 170 (commercial power grid, industrial power grid, generator, battery pack, etc.) and converts the received power into a form (waveform, voltage, etc.) usable by the digitally controlled lighting device 120 and/or the device driver 130. For example, using the DALI network protocol, the power supply 150 may provide an output voltage of about 16 VDC (+/−6.5 VDC) to the network 160 when the device control circuitry 140 places the switching element 140 in the first operating mode.

The network 160 may include a wired network, wireless network, or combinations thereof. In some embodiments, the network 160 may include a serial topography, a star topography, or any combination of serial and star topographies. In some embodiments, the network 160 may include a wired or wireless mesh network topology where device drivers 130 coupled to the network 160 have the ability to exchange messages with each other. In some embodiments, the network 160 may include, but is not limited to, a DALI protocol two wire network operating at voltages between 0 VDC and 16 VDC. In some embodiments, the network 160 may include a short-range wireless local area network (WLAN) that uses Institute of Electrical and Electronics Engineers standard 802.15.4 (IEEE 802.15.4—latest version) running a ZIGBEE® wireless protocol. In some embodiments, the network 160 may include a wireless personal area network (WPAN) using the IEEE 802.15.4 standard running a MiWi® or MiWi P2P (Microchip Technology®, Chandler, Ariz.) wireless protocol.

One or more remote devices 190 may be used to configure the network controller 110 and/or the digitally controlled lighting devices 120. In some embodiments, the one or more remote devices 190 may provide control programming for some or all of the plurality of digitally controlled lighting devices 120. The one or more remote devices 190 may include, but are not limited to one or more handheld processor-based devices, one or more portable processor-based devices; one or more laptops, one or more desktops, one or more workstations, one or more cloud-based servers, or any combination thereof.

The network 192 communicably couples the network controller 190 with the one or more remote devices or systems 190. The one or more networks 192 may include any number and/or combination of local area networks (LANs, including BLUETOOTH®; Near Field Communication/NFC, ZIGBEE®, and similar); wireless local area networks (WLANs); cellular networks; wide area networks (WANs); and/or worldwide area networks (WWANs, such as the Internet).

In some embodiments, upon initial commissioning, the network control circuit 112 receives information and/or data from the device drivers 130A-130n in each of the network connected digitally controlled lighting devices 120A-120n. Each of the device drivers 130 includes a switching element 142 having at least two operating modes. In the first operating mode, the device driver provides power to the network 160 at a first output voltage and a first output current. In the second operating mode, the device driver does not provide power to the network 160.

The information and/or data received by the network controller 110 includes at least one power output parameter (first output voltage, first output current, etc.) associated with the respective device driver 130A-130n. Using the received information in conjunction with stored information and/or data representative of one or more network operating parameters (maximum allowable current, etc.) and one or more network controller operating parameters (operating current, etc.), the network controller determines a number of device drivers 130 to couple to the network 160 in order to provide power to the network controller 110 when the device drivers are placed in the first operating mode. The network controller 110 may also determine whether additional device drivers 130, also in the first operating mode, may be coupled to the network to provide a level of operational redundancy should a fault occur in one of the device drivers 130. After determining the number of device drivers 130 to couple to the network 160, the network controller causes the device drivers 130 in a first portion of the network connected digitally controlled lighting devices 120 to transition to the first operating mode. The network controller 110 causes the device drivers 130 in the remaining portion of the network connected digitally controlled lighting devices 120 to transition (or remain) in the second operating state.

To communicate a message from the network controller 110 across the network 160, the network control circuit 112 may cause all device drivers 130 to enter the first operational state until the message transmission is complete. To communicate a message from a device driver 130 to the network control circuit 112, the network control circuit 112 may cause all device drivers 130 (except for the transmitting device driver 130) to enter the first operational state until the message transmission is complete. Upon completion of the message transmission, the network control circuit 112 can cause the device drivers 130 in the first portion of the digitally controlled lighting devices 120 to return to the first operational mode, supplying power to the network controller 110 via the network 160.

The network control circuit 112 may intermittently, continuously, periodically, or aperiodically monitor at least the device drivers 130 included in the first portion of the plurality of digitally controlled lighting devices 120 for one or more fault conditions (over-current, under-current, over-voltage, under-voltage, thermal excursions, etc.). Upon detecting a fault condition in a device driver 130 included in the first portion of the plurality of digitally controlled lighting devices 120, the network control circuit 112 may autonomously cause the respective device driver 130 to transition from the first operating mode to the second operating mode (i.e., the respective device driver ceases supplying power to the network and the respective digitally controlled lighting device 120 is no longer included in the first plurality of digitally controlled lighting devices 120). In addition, the network control circuit 112 may autonomously cause a device driver 130 in one of the digitally controlled lighting devices 120 included in the remaining portion of the plurality of digitally controlled lighting devices 120 to transition from the second operating mode to the first operating mode (i.e., the respective device driver 130 begins supplying power to the network and the respective digitally controlled lighting device 120 is now included in the first plurality of digitally controlled lighting devices 120).

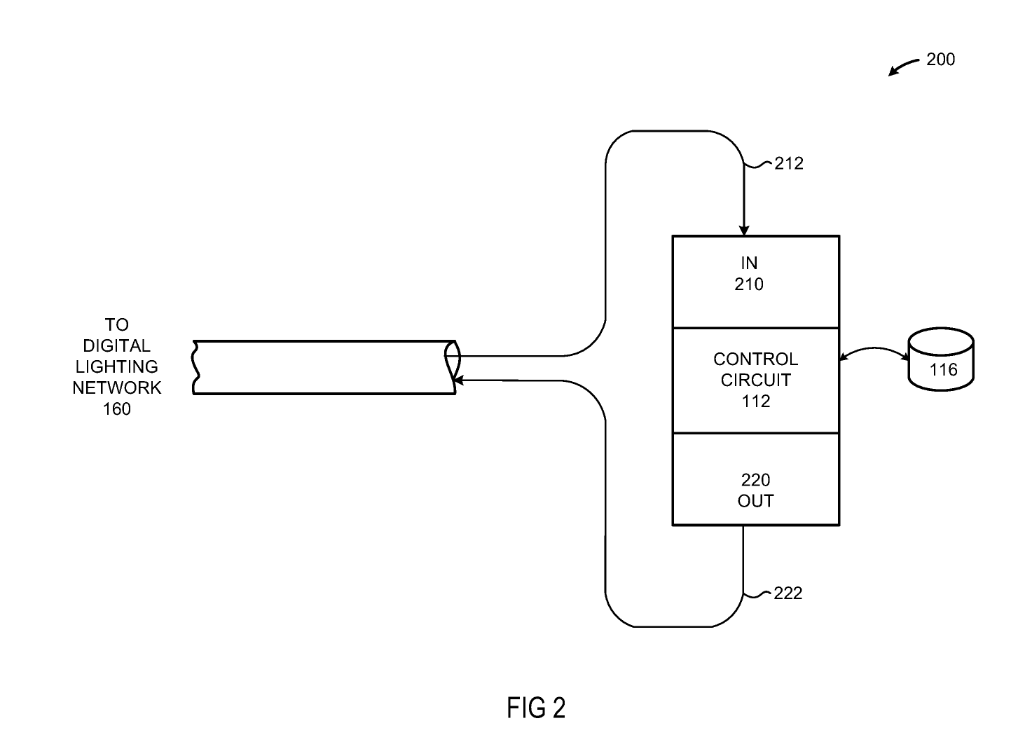

FIG. 2 is an input/output diagram of a system 200 that includes a network control circuit 112 coupled to a two-wire network 160, in accordance with at least one embodiment described herein. As depicted in FIG. 2, the network controller 110 includes at least in input connection 210 and at least one output connection 220. In some embodiments, the network control circuit 112 may receive messages from a device driver 130 in the form of a digital signal 212 received at an input of the network control circuit 112. In some embodiments, the network control circuit 112 may communicate messages to one or more device drivers 130 in the form of a digital signal 222 generated at an output of the network control circuit 112.

For example, in some embodiments, the network control circuit 112 may generate a digital signal 222 that includes a message querying each of the device drivers 130 for information and/or data associated with the power output of the respective device driver 130. In response, the network control circuit 112 may receive a digital signal 212 that includes power output parameters from each of at least some of the device drivers 130 included in the plurality of digitally controlled lighting devices 120. In response, the network control circuit 112 may determine a number of device drivers 130 to fulfill the power draw of the network controller 110. Once the device drivers 130 included in a first portion of the plurality of digitally controlled lighting devices 120 are identified as providing sufficient power to the network controller 110, the network control circuit may generate one or more digital signals 222 that include a message placing the device drivers 130 in each of the first portion of the digitally controlled lighting devices 120 into a first operating mode in which the respective device drivers 130 provide power to the network 140. The network control circuit may generate one or more additional digital signals 222 that include a message placing the device drivers 130 in each of the remaining portion of the digitally controlled lighting devices 120 into a second operating mode in which the respective device drivers 130 do not provide power to the network 140.

The network control circuit 112 may periodically, aperiodically, continuously, or intermittently generate one or more digital signals 222 that include a message querying each of the device drivers 130 included in the first portion of the digitally controlled lighting devices 120 to detect the existence of a fault condition in the respective device driver 130. In response, the network control circuit 112 may receive a digital signal 212 from each of at least some of the device drivers 130 included in the first portion of the digitally controlled lighting devices 120 that includes a message identifying one or more operating parameters of the respective device driver 130 and/or whether a fault condition exists within the respective device driver 130.

Using the information provided by the device drivers 130, the network control circuit 112 determines whether a fault condition exists in the respective device driver 130. If a fault condition exists, the network control circuit 112 may generate one or more digital signals 222 that include a message instructing the faulty device driver 130 to transition from the first operating mode to the second operating mode. Additionally, the network control circuit 112 may generate one or more digital signals 222 that include a message instructing the a device driver 130 in one of the remaining portion of digitally controlled lighting devices 120 to transition from the second operating mode to the first operating mode to replace the faulty device driver 130.

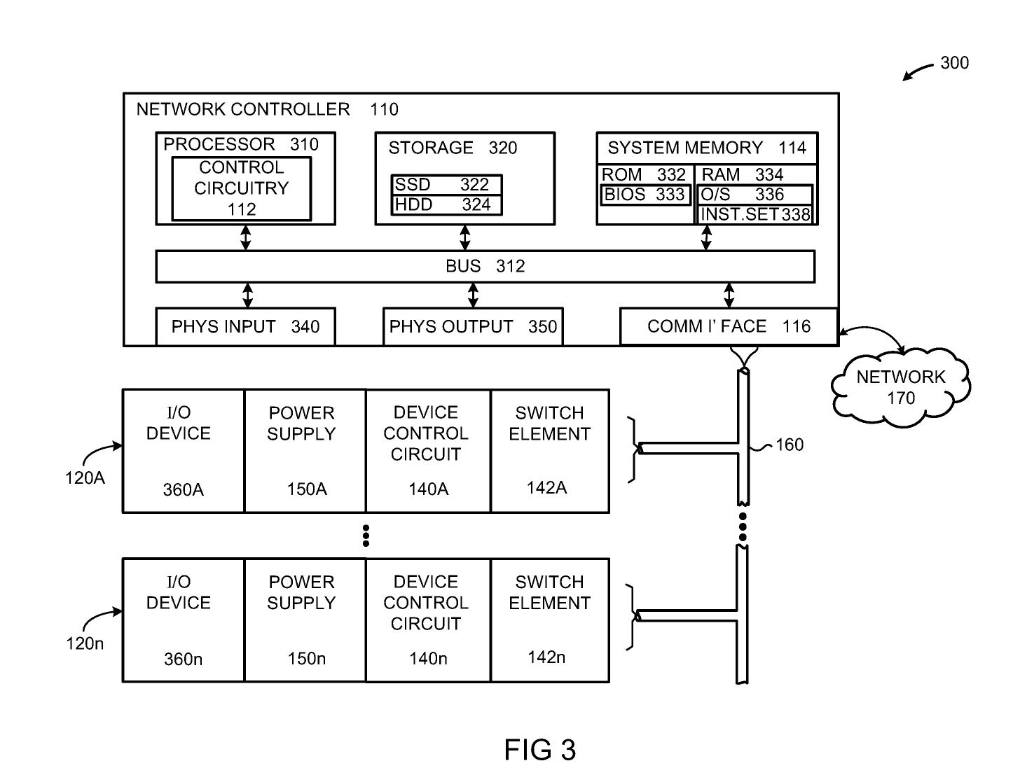

FIG. 3 is a block diagram of an illustrative system 300 that includes a network controller 110 communicably coupled to a plurality of digitally controlled lighting devices 120A-120n via a network 160, in accordance with at least one embodiment described herein. The following discussion provides a brief, general description of the components forming the illustrative system 300 that provides autonomous addressing for a network of digitally controlled lighting devices 120A-120n. The system 300 may use a wired or wireless network to communicate using a proprietary or industry standard communications protocol (ZIGBEE®, MiFi®, DALI, etc.). The network controller 110 may receive at least a portion of its operating power from device drivers 130 included in a first portion of the digitally controlled lighting devices 120.

The network controller 100 includes a network control circuit 112 capable of executing machine-readable instruction sets, reading data from a non-transitory memory or storage device 116 and writing data to the non-transitory memory or storage device 116. Those skilled in the relevant art will appreciate that the illustrated embodiments as well as other embodiments can be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like.

The processor 310 may include any number of hardwired or configurable circuits, some or all of which may include programmable and/or configurable combinations of electronic components, semiconductor devices, and/or logic elements that are disposed partially or wholly in a PC, server, or other computing system capable of executing machine-readable instructions. In embodiments, at least a portion of the circuitry disposed in the processor 310 may form, provide, or otherwise enable the network control circuit 112.

The network controller 110 includes the processor circuitry 310 and a bus or similar communications link 312 that communicably couples and facilitates the exchange of information and/or data between various system components including the network control circuit 112, the non-transitory memory or storage device 116, and/or one or more storage devices 320. The network controller 110 may be referred to in the singular herein, but this is not intended to limit the embodiments to a single device and/or system, since in certain embodiments, there will be more than one network controller 110 that incorporates, includes, or contains any number of communicably coupled, collocated, or remote networked circuits or devices.

The network controller 110 may include any number, type, or combination of electronic components, semiconductor devices, and/or logic elements. At times, the network controller 110 may be implemented in whole or in part in the form of semiconductor devices such as diodes, transistors, and integrated circuits. Such an implementation may include, but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 3 are of conventional design. Consequently, such blocks need not be described in further detail herein, as they will be understood by those skilled in the relevant arts. The communications link 312 that interconnects at least some of the components of the network controller 110 may employ any known serial or parallel bus structures or architectures.

The system memory 116 may include read-only memory (“ROM”) 332 and random access memory (“RAM”) 334. The system memory 116 may include any combination of persistent and/or non-transitory memory and non-persistent memory. A portion of the ROM 332 may be used to store or otherwise retain a basic input/output system (“BIOS”) 333. The BIOS 333 provides basic functionality to the network controller 110, for example by causing the processor 310 to load one or more machine-readable instruction sets. In embodiments, at least some of the one or more machine-readable instruction sets cause at least a portion of the processor 310 to provide, create, produce, transition, and/or function as a dedicated, specific, and particular machine, for example, a DALI compliant lighting network control circuit 112.

The network controller 110 includes the non-transitory storage 114. The non-transitory storage may include nay number and/or combination of systems and/or devices capable of storing information and/or data. Example non-transitory storage 114 includes, but is not limited to: one or more solid-state storage devices 322; one or more hard disk drives 324; and similar non-transitory electromagnetic, electroresistive, optical, molecular and quantum storage devices. In some implementations, the non-transitory storage 114 may include one or more removable storage devices, such as one or more flash drives, flash memories, flash storage units, or similar appliances or devices capable of communicable coupling to and decoupling from the network controller 110.

The non-transitory storage 114 may include interfaces or controllers (not shown) communicatively coupling the respective data storage device or system to the bus 312. The one or more non-transitory storage 114 may store, retain, or otherwise contain machine-readable instruction sets, data structures, program modules, data stores, databases, logical structures, and/or other data useful to the network control circuit 112 and/or one or more applications executed on or by the network control circuit 112. In some instances, the non-transitory storage 114 may be communicably coupled to the network control circuit 112, for example via bus 312 or via one or more wired communications interfaces (e.g., Universal Serial Bus or USB); one or more wireless communications interfaces (e.g., BLUETOOTH®, Near Field Communication or NFC); one or more wired network interfaces (e.g., IEEE 802.3 or Ethernet); and/or one or more wireless network interfaces (e.g., IEEE 802.11 or WiFi®)).

An operating system 336 and one or more machine-readable instruction sets 338 may be stored in or otherwise transferred to, in whole or in part, the RAM 334 portion of the system memory 330. Such instruction sets 338 may be transferred, in whole or in part, from the one or more solid state storage devices 332 and/or the one or more hard disk drives 534. The instruction sets 338 may be loaded, stored, or otherwise retained in system memory 330, in whole or in part, during execution by the processor 310. The machine-readable instruction sets 338 may include machine-readable and/or processor-readable code, instructions, or similar logic capable of providing the autonomous network addressing functions and capabilities described herein.

A system user may provide, enter, or otherwise supply commands (e.g., selections, acknowledgements, confirmations, and similar) as well as information and/or data (e.g., subject identification information, color parameters) to the network controller 110 using one or more communicably coupled input devices 340. The one or more communicably coupled input devices 340 may be disposed local to or remote from the network controller 110. The input devices 340 may include one or more: text entry devices (e.g., keyboard); pointing devices (e.g., mouse, trackball, touchscreen); audio input devices; video input devices; and/or biometric input devices (e.g., fingerprint scanner, facial recognition, iris print scanner, voice recognition circuitry). In embodiments, at least some of the one or more input devices 340 may include a wired or wireless interface that communicably couples the input device 340 to the network controller 110.

The system user may receive output generated by the network controller 110 via one or more output devices 350. In at least some implementations, the one or more output devices 350 may include, but are not limited to, one or more: biometric output devices; visual output or display devices; tactile output devices; audio output devices, or combinations thereof. In embodiments, at least some of the one or more output devices 350 may include a wired or a wireless communicable coupling to the network controller 110.

The network controller 110 further includes one or more switching elements 114. The one or more switching elements 114 may include any number and/or combination of systems and/or devices capable of selectively reversibly providing an electrically conductive and an electrically non-conductive path between conductors forming the two-wire network 160 or a conductor and ground in a one-wire network. In some embodiments, the one or more switching elements 114 may include one or more mechanical or electromechanical switching devices. In some embodiments, the one or more switching elements 114 may include one or more semiconductor devices, such as a field effect transistor (FET).

For convenience, the processor circuitry 310, the storage devices 320, the non-transitory memory or storage device 116, the input devices 340 the output devices 350, and the one or more switching elements 114 are illustrated as communicatively coupled to each other via the bus 312, thereby providing connectivity between the above-described components. In alternative embodiments, the above-described components may be communicatively coupled in a different manner than illustrated in FIG. 3. For example, one or more of the above-described components may be directly coupled to other components, or may be coupled to each other, via one or more intermediary components (not shown). In some embodiments, all or a portion of the bus 312 may be omitted and the components are coupled directly to each other using suitable wired or wireless connections.

Each of the digitally controlled lighting devices 120A-120n includes at least: one or more respective input/output devices 360A-360n (collectively, “I/O devices 360”); a respective power supply 150A-150n; a respective device control circuitry 140A-140n; and one or more respective switching elements 142A-142n. Each of the digitally controlled lighting devices 120 may include the same or different input/output devices 360. For example, a first portion of the digitally controlled lighting devices 120 may include one or more output devices 360, such as a dimmable light emitting diode (LED) luminaire and a second portion of the digitally controlled lighting devices 120 may include one or more input devices 360 (switches, motion sensors, proximity sensors, etc.) that control one or more operating parameters or operational aspects (luminous intensity, color, temperature, etc.) of the dimmable LED luminaires.

The I/O devices 360 may include any number and/or combination of input devices and/or output devices. Input devices 360 may include any number and/or combination of systems and/or devices capable of generating an output signal that may be communicated from the digitally controlled lighting device 120 to the network controller 110. Example input devices 360 include, but are not limited to: dimmer switches, ON/OFF switches, motion sensors, proximity sensors, photoelectric sensors, timers, piezoelectric sensors, or combinations thereof. Example input devices 360 may provide an indication that a change in illumination level is appropriate based on an event (e.g., presence of an individual) or based on a schedule (e.g., store closing time).

Output devices 360 may include any number and/or combination of systems or devices capable of providing a human perceptible output. Such devices may include dimmable incandescent, fluorescent, metal halide, sodium vapor, or LED luminaires. In embodiments, a plurality of output devices 360, such as red LEDs, green LEDs, and blue LEDs, may be controlled by a single digitally controlled lighting device 120.

The power supply 150 may receive single or multi-phase line power (e.g., 110 VAC, 240 VAC, 480 VAC, or similar) and may convert the received line power to a suitable form and voltage to power the I/O device 360, the device control circuitry 140 and/or the switching element 142. The power supply 150 may provide power to the network 160 based, at least in part on the position and/or operating mode of the one or more switching elements 142. In some implementations, the power supply 150 may provide a pulse width modulated (PWM) signal to the I/O devices 360 (e.g., LED output devices) to control the duty cycle of the I/O devices and therefore the color, temperature, and/or intensity of the I/O devices 360. In some embodiments, the power supply 150 may provide two or more output voltages to power the I/O devices 360, device control circuitry 140, system memory 116, and/or storage devices 320.

The device control circuitry 140 may include any number and/or combination of electrical components, semiconductor devices, and/or logic elements capable of receiving instructions from the network control circuit 112, controlling the I/O device 360, regulating the output from the power supply 150, reading from and writing to the device memory 116 transmitting and/or receiving signals containing commands, information, and/or data via the one or more switching elements 142. In some embodiments, the device control circuitry 140 may be disposed or otherwise formed in a processor or similar computing device that may include, but is not limited to, an 8-bit microcontroller unit (MCU) configured to communicate with the network control circuit 112 using any industry standard or proprietary communications protocol. In some embodiments, the processor 380 may include a 16-bit, 32-bit, or even 64-bit processor capable of providing the device control circuitry 140 and communicating with the network control circuit 112 using ZIGBEE®, BLUETOOTH®, IEEE 802.11, or MiFi® communications protocol.

The one or more switching elements 142 may include any number and/or combination of mechanical, electromechanical, and/or semiconductor switches operably couplable to the device control circuitry 140. In some embodiments, the one or more switching elements 142 may include one or more semiconductor switches, such as one or more field-effect transistors.

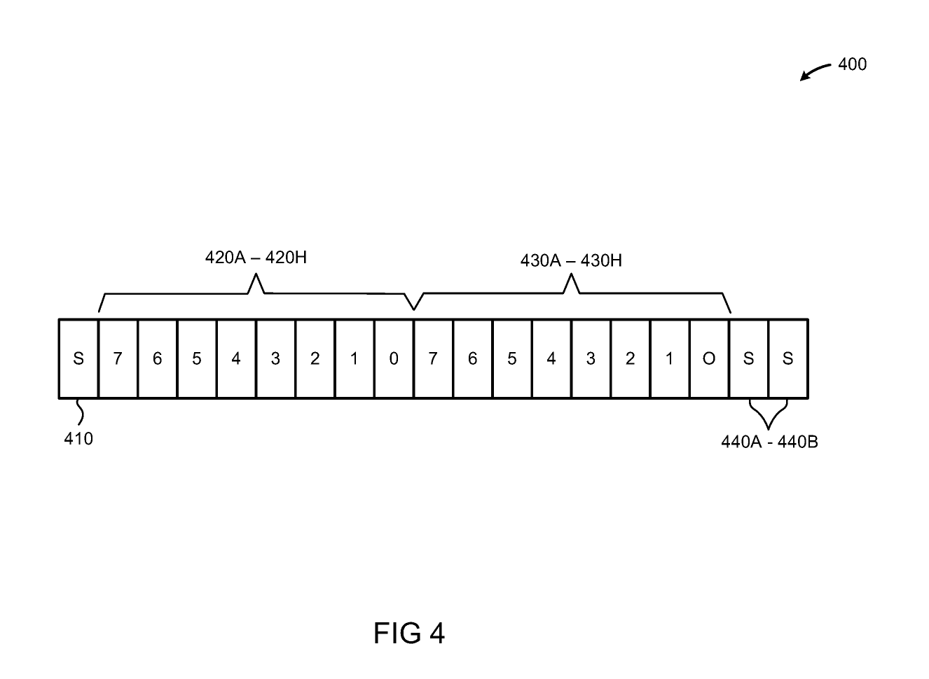

FIG. 4 is an illustrative message 400 generated using a DALI compliant messaging protocol, in accordance with at least one embodiment described herein. The DALI messaging protocol uses a Manchester encoded, nominal 0 VDC to 16 VDC, signal in which a rising voltage (i.e., anything less than 6.5 VDC RISING to greater than 9.5 VDC represents a binary HIGH or “1” signal) and in which a falling voltage (i.e., anything greater than 9.5 VDC falling to less than 6 VDC represents a binary LOW or “0” signal). As depicted in FIG. 4, the DALI messaging protocol begins a message with a start bit 410, followed by an 8-bit 420A-420H address field, followed by an 8-bit command field 430A-430H, closed by two stop bits 440A, 440B. The DALI communication protocol supports a 1200 baud data rate across the network 160.

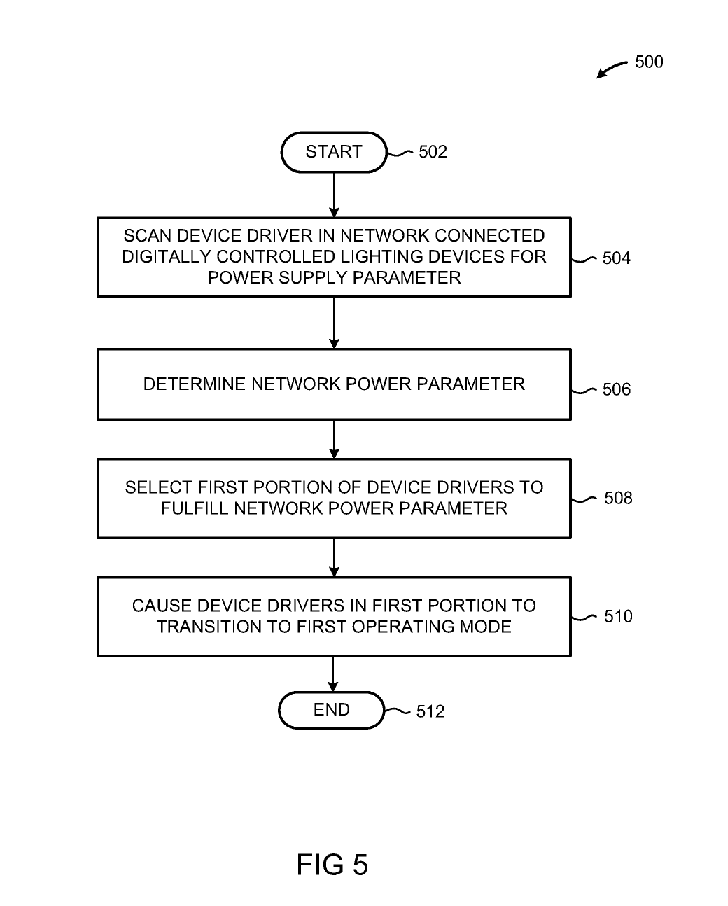

FIG. 5 is a high-level flow diagram of an illustrative method 500 of autonomously powering a network controller 110 using power provided to the network 160 by a device drivers 130 included in a first portion of a plurality of digitally controlled lighting devices 120, in accordance with at least one embodiment described herein. A network controller 110 may cause the device drivers 130 included in a first portion of the digitally controlled lighting devices 120 to transition to a first operating mode in which the device drivers 130 provide power to the network 160 at a level sufficient to support the operation of the network controller 110. The network controller 110 may cause the device drivers 130 in the remaining portion of the digitally controlled lighting devices 120 to transition to a second operation mode in which the device drivers 130 fail to provide power to the network 160. The method 500 beneficially provides for the automatic configuration of device drivers 130 to provide network power to the network controller 110, thereby reducing or eliminating the need to independently power the network controller while, at the same time, beneficially increasing the robustness and reliability of the lighting system, by distributing a former single point of failure (a power supply in the network controller) with multiple redundant power supplies having an autonomous rollover capability. The method 500 commences at 502.

At 504, the network controller 110 communicates a message to the device drivers 130 in each of a plurality of digitally controlled lighting devices 120 that requests the respective device driver 130 to respond with information and/or data associated with one or more power output parameters of the respective device driver 130. In response to the request, each of the device drivers 130 responds to the network controller 110 with a message that includes information and/or data associated with the power output parameters of the device driver 130. For example, the device driver 130 may respond with a message that provides the network controller 110 with information and/or data representative of a first output voltage and/or a first output current the device driver 130 provides to the network 160 when the device driver 130 is in a first operating mode. In one example, twenty (2) device drivers 130 may respond with a message that includes information representative of a first output voltage of 16 VDC and a first output current of 50 mA.

At 506, the network control circuit 112 determines one or more network power parameters. In some embodiments, the one or more network power parameters may be stored or otherwise retained in the non-transitory memory or storage device 116. The one or more network power parameters may include, but are not limited to, an allowable network operating voltage and/or an allowable network operating current. Continuing with the example from 504, the network control circuit 112 may receive information representative of an allowable network operating current of 250 mA.

At 508, the network control circuit 112 selects a first portion of the digitally controlled lighting devices 120 that include a number of device drivers 130 to provide a combined first current output to power the network controller 110 while the combined first current output remains safely beneath than the allowable network operating current. Continuing with the example from 504 and 506 above, if the current draw of the network controller 110 is 110 mA, three (3) device drivers 130 provide sufficient current (150 mA) to power the network controller via the network 160. The network control circuit 112 may select an additional device driver to provide failover capability if one of the device drivers 130 unexpectedly fails or develops a fault condition. Thus, the first portion of the digitally controlled lighting devices 120 will include a total of four (4) digitally controlled lighting devices 120. The remaining portion of the plurality of digitally controlled lighting devices 120 will include sixteen (16) digitally controlled lighting devices 120.

At 510, the network control circuit 112 causes the device drivers 130 included in the first portion of the digitally controlled lighting devices 120 to transition from a second operating state in which the device driver 130 does not provide power to the network 160 to a first operating state where each of the device drivers 130 provides power to the network controller 110 via the network 160. At 510, the network 160 receives the first output current at the first output voltage from each of the device drivers 130. The method 500 concludes at 512

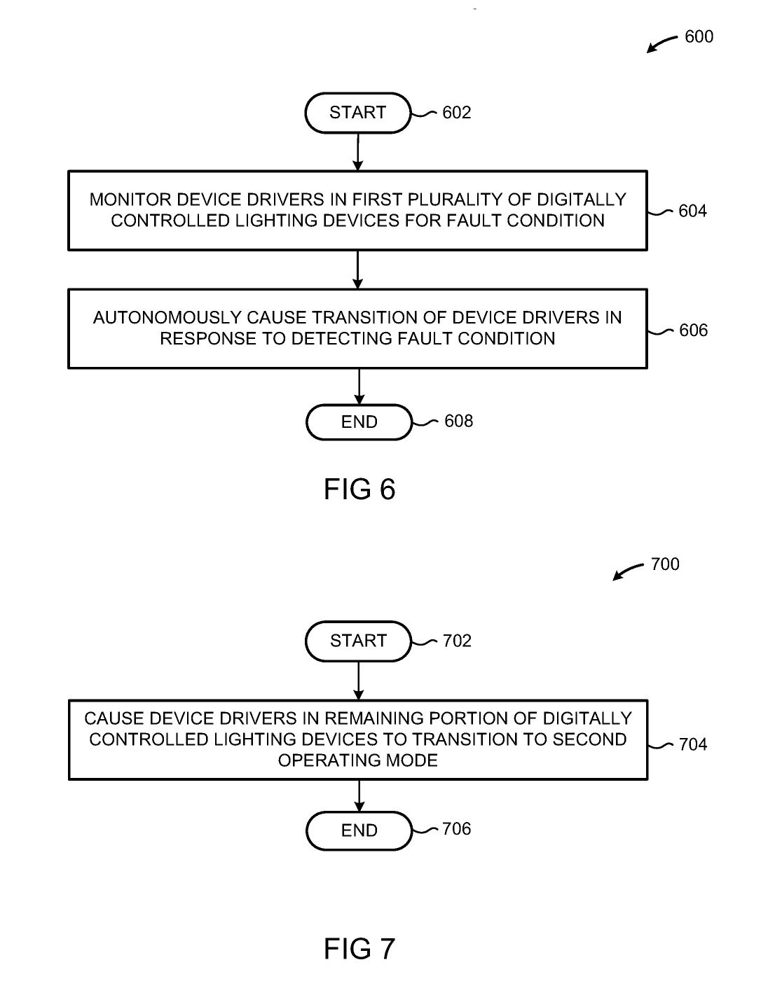

FIG. 6 is a high-level flow diagram of an illustrative method 600 of autonomously detecting by the network control circuit 112 a faulty device driver 130 included in the first portion of digitally controlled lighting devices 120 and autonomously causing the faulty device driver 130 to transition from the first operating mode to the second operating mode, in accordance with at least one embodiment described herein. The method 600 may be used in conjunction with the method 500 depicted in FIG. 5. The network control circuit 112 continuously, intermittently, periodically, or aperiodically monitors the condition of each of the device drivers 130 included in the first portion of digitally controlled lighting devices 120. Upon detecting a fault condition in one of the device drivers 130 included in the first portion of digitally controlled lighting devices 120, the network control circuit 112 seamlessly and autonomously transitions a replacement device driver 130 from the remaining portion of digitally controlled lighting devices 120 to provide network power. The method 600 commences at 602.

At 604, the network control circuit 112 continuously, intermittently, periodically, or aperiodically monitors each of the device drivers 130 included in at least the first portion of digitally controlled lighting devices 120 to detect one or more fault conditions (over- or under-current, over- or under-voltage, thermal fault, etc.). In some embodiments, the network control circuit 112 polls each of the device drivers 130 included in the first portion of digitally controlled lighting devices 120 to detect the one or more fault conditions. In some embodiments, the device driver 130 may communicate a message containing information and/or data representative of a fault condition to the network control circuit 112 upon self-detecting the fault condition.

At 606, in response to receipt of information and/or data indicative of a fault condition existing in one of the device drivers 1309 include in the first portion of digitally controlled lighting devices 120, the network control circuit 112 generates one or more messages that cause the faulty device driver 130 to transition from the first operating mode to the second operating mode where the respective device driver does not provide power to the network 160. The method 600 concludes at 608.

FIG. 7 is a high-level flow diagram of an illustrative method 700 of autonomously transitioning a device driver 130 included in the remaining portion of digitally controlled lighting devices 120 to the first operating mode in response to detecting a faulty device driver 130 included in the first portion of digitally controlled lighting devices 120, in accordance with at least one embodiment described herein. The method 700 may be used in conjunction with some or all of: method 500 described in detail in FIG. 5 and/or method 600 described in detail in FIG. 6. The network control circuit 112 may include an additional device driver 130 in the first portion of the digitally controlled lighting devices 120 to provide seamless switchover capability. To complete the seamless switchover, the network control circuit 112 transitions a replacement device driver 130 included in the remaining portion of digitally controlled lighting devices 120. The method 700 commences at 702.

At 704, responsive to detecting a fault in one of the device drivers 130 included in the first portion of digitally controlled lighting devices 120\, the network control circuit 112 causes a device driver 130 included in the remaining portion of digitally controlled lighting devices 120 to transition from the second operating mode to the first operating mode. By transitioning one of the device drivers 130 included in the remaining portion of digitally controlled lighting devices 120, the network control circuit 112 replaces the faulty device driver 130 and beneficially restores the seamless switchover capability of the network 160. The method 700 concludes at 706.

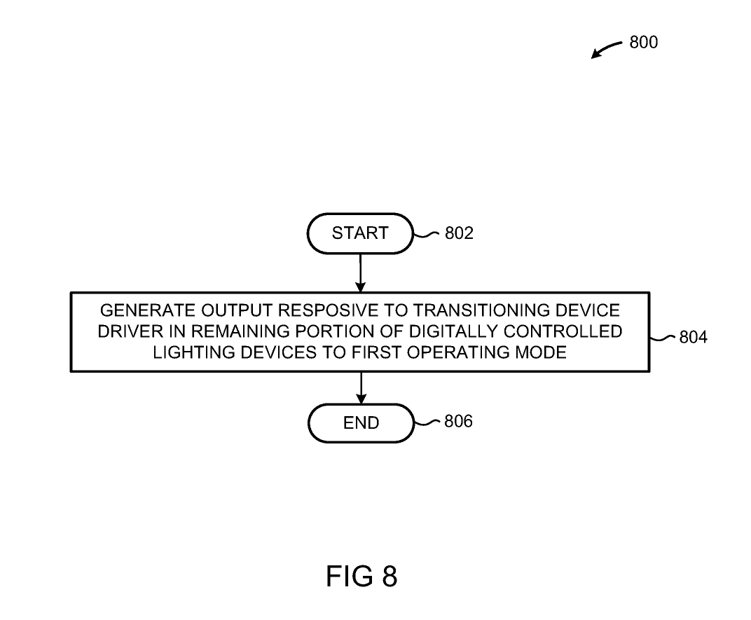

FIG. 8 is a high-level flow diagram of an illustrative method 800 of autonomously generating a human perceptible output responsive to detecting a faulty device driver 130 included in the first portion of digitally controlled lighting devices 120, in accordance with at least one embodiment described herein. The method 800 may be used in conjunction with some or all of: the method 500 described in detail in FIG. 5, the method 600 described in detail in FIG. 6, and/or the method 700 described in detail in FIG. 7. Since the network control circuit 112 autonomously resolves faulty device driver 130 using a replacement device driver included in the remaining portion of digitally controlled lighting devices 120, generating a human perceptible output may beneficially alert a system attendant to potential problems with the faulty device driver 130. The method 800 commences at 802.

At 804, the network control circuit 112 generates an output signal that includes data representative of a human-perceptible alert in response to transitioning a device driver 130 from the first operating mode to the second operating mode. The data may represent an audible alert, a visual alert, a tactile alert, or combinations thereof. The method 800 concludes at 806.

While FIGS. 5 through 8 illustrate various operations according to an embodiment, it is to be understood that not all of the operations depicted in FIGS. 5 through 8 are necessary for other embodiments. Indeed, it is fully contemplated herein that in other embodiments of the present disclosure, the operations depicted in FIGS. 5 through 8 and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

Thus, this disclosure is directed to power distribution in network systems that include a plurality of networked digitally controlled devices and a network powered network controller. Each of the digitally controlled devices includes a device driver that coupled to the network. The device driver is selectively transitionable between a first operating mode in which the device driver provides a first voltage and a first current to the network and a second operating mode where the driver does not provide a voltage or current to the network. The network controller autonomously determines a number of device drivers that, in the first operating mode, at least meet the current draw of the network controller. The network controller then transitions the determined number of device drivers to the first operating mode. The network controller monitors the device drivers for faults and autonomously swaps device drivers to maintain network power.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A network power distribution system, comprising:
a plurality of digitally controlled lighting devices, each of the plurality of digitally controlled lighting devices communicably coupled to a 2-wire network and comprising a device driver to provide an output to the 2-wire network, the output selectively, reversibly, transitionable between a first voltage and a second voltage;
a network controller, comprising a network control circuit communicably couplable to each of the device drivers via the 2-wire network, the network controller to receive power at the first voltage, via the 2-wire network, from a first portion of the plurality of device drivers; and
a non-transitory storage medium containing machine-readable instructions that, when executed by the network controller cause the network control circuit to:
scan each device driver to determine at least one device power supply parameter associated with a power output to the 2-wire network by the respective device driver, the power output provided at the first voltage and a first current;
determine at least one network power parameter;
select a first portion of the digitally controlled lighting devices from the plurality of digitally controlled devices, the first portion of digitally controlled lighting devices selected based on the power supply parameter of the device driver included in each of the first portion of digitally controlled lighting devices and the at least one network power parameter; and
cause the device drivers included in the first portion of the digitally controlled lighting devices to operate in a first operating mode where the respective device driver provides a power output to the 2-wire network at the first voltage and the first current.

2. The network power distribution system of claim 1, wherein the machine-readable instructions further cause the network control circuit to:
monitor each of the device drivers included in the first portion of digitally controlled lighting devices; and
responsive to detecting a fault condition in one of the device drivers included in the first portion of digitally controlled lighting devices, autonomously cause the respective device driver to transition from the first operating mode to a second operating mode in which the respective device driver does not provide a power output to the 2-wire network.

3. The network power distribution system of claim 2, wherein the machine-readable instructions further cause the network control circuit to cause device drivers in each of the remaining portion of digitally controlled lighting devices to remain in the second operating mode in which the device drivers do not provide a power output to the network.

4. The network power distribution system of claim 3, wherein the machine-readable instructions further cause the network control circuit to, responsive to detecting a fault condition in one of the device drivers included in the first portion of digitally controlled lighting devices, autonomously cause a device driver included in a remaining portion of the plurality of digitally controlled lighting devices to transition from the second operating mode to the first operating mode.

5. The network power distribution system of claim 4, wherein the machine-readable instructions further cause the network control circuit to generate a human-perceptible alert when the network control circuit transitions a device driver in the remaining portion of digitally controlled lighting devices from the second operating mode to the first operating mode.

6. The network power distribution system of claim 2, wherein the machine-readable instructions further cause the network control circuit to generate a human-perceptible alert when the network control circuit transitions a device driver included in the first portion of digitally controlled lighting devices from the first operating mode to the second operating mode.

7. The network power distribution system of claim 2, wherein the machine-readable instructions that cause the network control circuit to monitor each of the device drivers included in the first portion of digitally controlled lighting devices, further cause the network control circuit to monitor the device drivers included in each of the first portion of digitally controlled lighting devices to detect at least one of: an under-current fault condition or an over-voltage fault condition.

8. The network power distribution system of claim 1, wherein the network power parameter comprises a maximum allowable network current, and wherein the at least one device power supply parameter associated with the power supplied to the 2-wire network by the respective device driver comprises a supply current provided by the respective device driver.

9. The network power distribution system of claim 1, wherein the first voltage comprises a voltage of from +9.5 VDC to +22.5 VDC, and the second voltage comprises a voltage of from −6.5 VDC to +6.5 VDC.

10. A network power distribution method, comprising:
scanning, by a network control circuit, each of a plurality of networked digitally controlled lighting devices to determine at least one output parameter associated with a device driver included in each at least some of the plurality of digitally controlled lighting devices, the device driver to provide an output to a 2-wire network, the output selectively, reversibly, transitionable between a first voltage and a second voltage;
determining at least one network power parameter;
selecting a first portion of the digitally controlled lighting devices from the plurality of digitally controlled devices, the first portion of digitally controlled lighting devices selected, by the network control circuit, based on the output parameter of the device driver included in each of the first portion of digitally controlled lighting devices and the at least one network power parameter; and
autonomously causing, by the network control circuit, the device drivers included in the first portion of the digitally controlled lighting devices to operate in a first operating mode where the respective device driver provides a power output to the 2-wire network at the first voltage and a first current.

11. The network power distribution method of claim 10, further comprising:
monitoring, by the network control circuit, each of the device drivers included in the first portion of digitally controlled lighting devices; and
responsive to detecting a fault condition in one of the device drivers included in the first portion of digitally controlled lighting devices, autonomously causing the respective device driver to transition from the first operating mode to a second operating mode in which the respective device driver does not provide the power output to the network.

12. The network power distribution method of claim 11, further comprising:
autonomously causing, by the network control circuit, device drivers in each of a remaining portion of digitally controlled lighting devices to remain in the second operating mode.

13. The network power distribution method of claim 12, further comprising:
generating, by the network control circuit, an output signal that includes data representative of a human-perceptible alert when a device driver included in the first portion of digitally controlled lighting devices transitions from the first operating mode to the second operating mode.

14. The network power distribution method of claim 12, wherein autonomously causing the respective device driver to transition from the first operating mode to a second operating mode further comprises:
autonomously causing a device driver the remaining portion of the plurality of digitally controlled lighting devices transition from the second operating mode to the first operating mode.

15. The network power distribution method of claim 11, wherein monitoring, by the network control circuit, each of the device drivers included in the first portion of digitally controlled lighting devices further comprises:
monitoring, by the network control circuit, the device drivers included in the first portion of digitally controlled lighting devices to detect at least one of: an under-current fault condition or an over-voltage fault condition.

16. The network power distribution method of claim 10, wherein determining at least one network power parameter further comprises:
determining, by the network control circuit, a maximum allowable network current.

17. The network power distribution method of claim 10, wherein autonomously causing the device drivers included in the first portion of the digitally controlled lighting devices to operate in a first operating mode comprises:
autonomously causing the device drivers included in the first portion of the digitally controlled lighting devices to provide the power output at a voltage of from +9.5 VDC to +22.5 VDC.

18. A non-transitory, machine-readable, storage medium containing instructions that, when executed by a network control circuit, cause the network control circuit to:
scan each of a plurality of networked digitally controlled lighting devices to determine at least one output parameter associated with a device driver included in each at least some of the plurality of digitally controlled lighting devices, the device driver to provide an output to a 2-wire network, the output selectively, reversibly, transitionable between a first voltage and a second voltage;
determine at least one network power parameter;
select a first portion of the digitally controlled lighting devices from the plurality of digitally controlled devices, the first portion of digitally controlled lighting devices selected, by the network control circuit, based on the power supply parameter of the device driver included in each of the first portion of digitally controlled lighting devices and the at least one network power parameter; and
autonomously cause, by the network control circuit, the device drivers included in the first portion of the digitally controlled lighting devices to transition to a first operating mode in which the respective device driver provides a power output to the 2-wire network, the power output at the first voltage and a first current.

19. The non-transitory machine-readable storage medium of claim 18, wherein the machine-readable instructions further cause the network control circuit to:
monitor each of the device drivers included in the first portion of digitally controlled lighting devices; and
responsive to detecting a fault condition in one of the device drivers included in the first portion of digitally controlled lighting devices, autonomously cause the respective device driver to transition from the first operating mode to a second operating mode in which the respective device driver does not provide the power output to the network.

20. The non-transitory machine-readable storage medium of claim 18, wherein the machine-readable instructions further cause the network control circuit to:
autonomously cause device drivers in each of a remaining portion of digitally controlled lighting devices to remain in the second operating mode.
